(19) United States
(12) Patent Application Publication
(10) Pub. No.: US 2008/0086930 A1
(43) Pub. Date: Apr. 17, 2008

(54) BUOYANCY COMPENSATING FISHING WEIGHT APPARATUS

(76) Inventor: Michael A. Swaney, Sebastopol, CA (US)

Correspondence Address: STAINBROOK & STAINBROOK, LLP, 412 AVIATION BOULEVARD, SUITE H, SANTA ROSA, CA, 95403, US

(21) Appl. No.: 11/874,085

(22) Filed: Oct. 17, 2007

Related U.S. Application Data
(60) Provisional application No. 60/829,752, filed on Oct. 17, 2006.

(51) Int. Cl. A01K 95/00

(52) U.S. Cl. 43/43.14

(57) ABSTRACT

A buoyancy compensating fishing weight apparatus including a weight, a hollow cylinder, and a length of wire or line disposed through each of the weight and the cylinder. The hollow cylinder is slightly elongate, waterproof, buoyant, deformable and flexible. Proximate the upper end of the cylinder, the line connects to a swivel or comparable fishing tackle element adapted for snap-on connection to a fishing line. A lower end of the lines terminates immediately below the weight in an element that prevents the line from removal through the weight or cylinder. The weight is attached to the lower end of the hollow cylinder with a watertight seal. The upper end of the line is disposed through a seal at the upper end of the hollow cylinder.

### CROSS REFERENCES TO RELATED APPLICATIONS

The present application claims the benefit of the filing date of U.S. Provisional Patent Application 60/829,752, filed 10/17/2006 (Oct. 17, 2006).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to fishing tackle, and more particularly to fishing weights, and still more particularly to a fishing weight having both buoyant and weighted sinking members.

2. Discussion of Related Art Including Information Disclosed Under 37 CFR §§1.97 1.98

Anglers must be adaptable to the particular environments in which they seek their catch. Even well known bodies of water change daily, and rivers are especially capricious. Accordingly, because certain species of fish prefer particular depths for feeding, it is critical that a fisherman be able to deliver his hook and bait or lure in the immediate vicinity of the sought after species. Depending on water currents, bait mass and buoyancy, line weight, and a host of other factors, it is frequently necessary to add weight to a fishing line to assist in delivering the tackle to the distance and optimum depth. As an ancient art, angling includes a highly developed population of tackle apparatus. Some recent art relevant to a consideration of the present application include:

U.S. Pat. No. 4,117,619 to Stevenson shows a fishing weight with an appended coil spring which is detachably attachable intermediate a leader and a flexible fishing line by weaving the leader and line with coils of the coil spring in a specific knotless manner that increases the gripping force of the coil spring upon application of a force normally tending to detach the leader and line from the weight.

U.S. Pat. No. 4,279,092 to Hutson teaches a fishing weight with a body having an axial channel containing a resilient but substantially incompressible insert such as nylon and with the body of the weight being formed with lips to retain the resilient insert and a recess proximate the insert into which a portion of the insert may flex for quick release or insertion of the fishing line.

U.S. Pat. No. 4,753,030 to Ziglinski discloses a fishing weight, particularly for steelhead fishing, made from a cylinder of thermoplastic material containing at least one spherical weight element retained by a melted and cooled closed end of the cylinder of thermoplastic material.

U.S. Pat. No. 4,819,364 to Lill teaches a pull-apart fishing weight with a separable head made of an elastomer resin and a weight member made of lead. The separable head contains two pins which are inserted in a friction fit into two aligned apertures in the weight. When the pull-apart fishing weight becomes entangled in an underwater obstruction, force may be applied to the separable head through the fishing line allowing the separable head to detach from the weight member and thereby preventing the line from snapping and the resulting loss of fishing tackle.

U.S. Pat. No. 5,157,860 to Clark shows a fishing weight having a body with a central through bore large enough to receive a fishing line along a central axis and a radial slot extending from the bore outwardly to the outer surface of the body, and a resilient, slightly compressible insert of substantially the same size as the slot and adapted to be manually pushed therein, the insert having a small tab extending rearwardly from the body and adapted to be a catch for a fingernail when prying the insert out of the slot.

U.S. Pat. No. 5,457,909 to Graves discloses a spherical fishing weight having a central bore to receive a fishing line and an opening transversely of the bore adapted to receive a retainer clip having serrations and which is inserted into the transverse opening to capture the line when compressed by the body walls.

U.S. Pat. No. 5,588,248 to Cornell, Jr., et al., discloses a fishing weight formed from a zinc alloy which is environmentally safe. It has a protective coating covering the entire outer surface. The covering is non-corrosive when exposed to water so that if it is chipped or broken, the environmentally safe zinc alloy of the weigh will not contaminate the environment.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is a new and improved buoyancy compensating fishing weight apparatus having three principal components, including a weight, buoyant cylinder, and clip or eyelet with wire or line connecting components. The cylinder is waterproof and is varied in length. It is also deformable and flexible, bending easily when in use.

At the upper end of the cylinder, the line or wire connects to a swivel or comparable fishing tackle element (an eyelet, for example) adapted for snap-on connection to a fishing line or leader having a complementary element. At the lower end of the assembly, immediately below the weight, the line terminates in either an element that prevents the line from being pulled through either the weight or the cylinder.

Assembly of the apparatus is simple and quick. The weight is brought into contact with the lower end of the hollow cylinder and the upper end of the line is brought close to the upper end of the cylinder. Seals are formed at both the upper and lower ends of the cylinder by dipping or coating the ends in a liquid rubber or plastic material. The ends thus include a flexible, deformable seal that prevents water incursion into the cylinder (when a hollow cylinder is employed) while allowing the line to flex and bend relatively freely.

A tackle box will include an assortment of the inventive assemblies having different widths and lengths, different sinker sizes and weights, various colors, and so forth.

It is therefore a first and primary object of the present invention to provide a new and improved buoyancy compensating fishing weight apparatus with adjustable buoyancy and weight elements to facilitate relatively precise control of the apparatus behavior in select fishing waters, whether still or swiftly running, deep or shallow.

It is another object of the present invention to provide a new and improved fishing weight made of inexpensive materials that make loss of the apparatus economically insignificant.

It is another object of the present invention to provide a new and improved fishing weight that may be rapidly installed on or removed from a fishing line.

A further object or feature of the present invention is to provide a new and improved adjustable fishing weight that is easily installed on typical fishing leader and line.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the specification be regarded as including such equivalent constructions as far as they do not depart from the spirit and scope of the present invention. For a better understanding of the present invention, its advantages and the specific objects attained by its uses, reference should be made to the accompanying drawings and descriptive matter in which there are illustrated the preferred embodiment.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the fishing weight assembly of the present invention;

FIG. 2 is an exploded side view in elevation showing elements of the inventive apparatus before complete assembly;

FIG. 3 is a side view in elevation showing the elements of FIG. 2 brought into the assembled configuration but before sealing; and

FIG. 4 shows the apparatus with the ends of the buoyant member sealed and thus the apparatus in the fully assembled configuration.

### DETAILED DESCRIPTION OF THE INVENTION

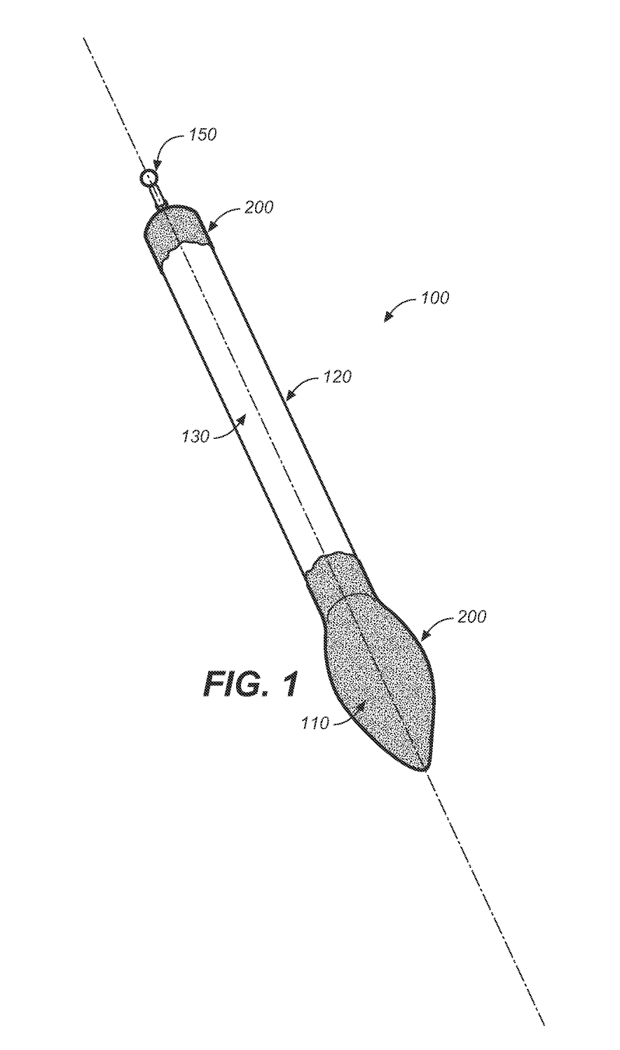

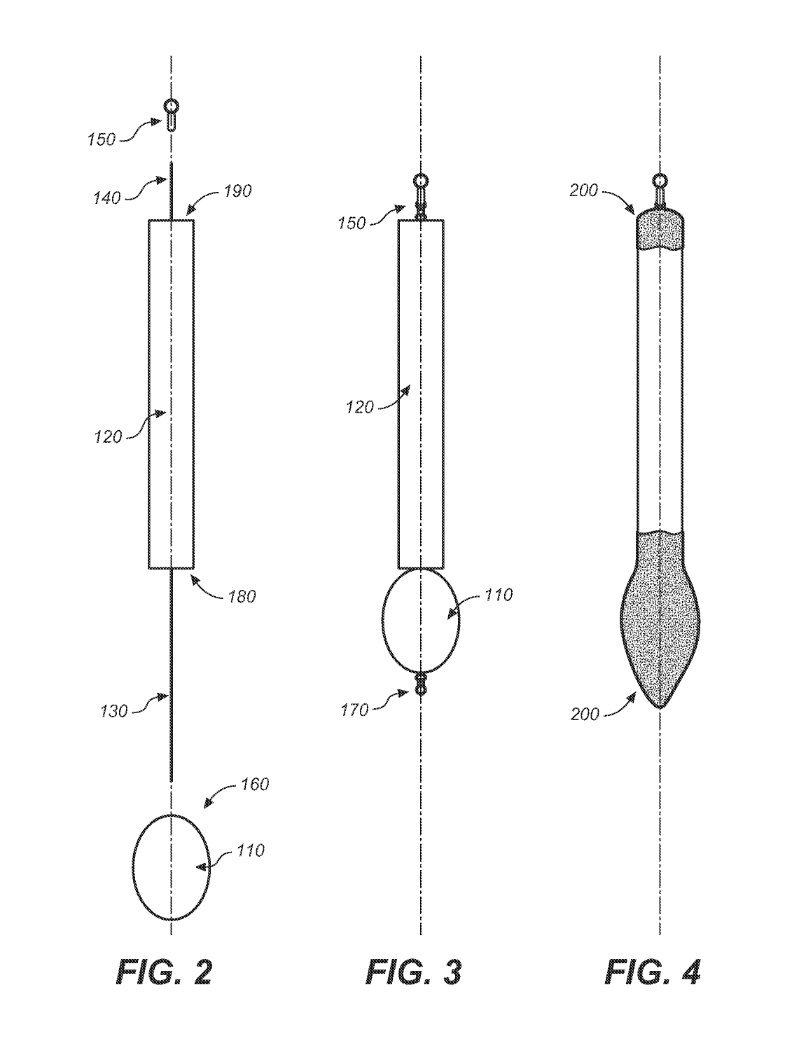

Referring to FIGS. 1 through 4, wherein like reference numerals refer to like components in the various views, there is illustrated therein a new and improved fishing weight, generally denominated 100 herein. These views collectively show that the inventive apparatus comprises three essential components, including a weight 110, a hollow cylinder 120, and a wire or line 130. The weight includes a through hole or bore through which the line is inserted. The line is also threaded through the hollow cylinder, which is preferably rubber, synthetic rubber, plastic, non-absorbent closed cell rubber foam or sponge material, high buoyancy cross-linked polyethylene closed cell foam (such as UltraFoam™ from American Micro Industries, Inc of Chambersburg Pa.), or any of a number of suitable thermoplastic materials that are buoyant, deformable and flexible, and therefore easily bent. Small gauge surgical tubing provides a good example of suitable cylinder materials and with the desirable characteristics.

On the upper end 140 of the assembly, the line is preferably attached to a swivel or eyelet 150 for easy snap-on connection to a fishing line or leader. On the lower end 160 of the assembly, the line is terminated in either a knot or a loop, or it is otherwise provided with a bead or other expansion 170 that prevents excursion of the line through and from the weight and through the cylinder.

When the apparatus is assembled, the weight is approximated to the lower end 180 of the hollow cylinder, while the swivel is approximated to the upper end 190 of the cylinder. Then seals are formed at each end by coating or dipping the ends in a liquid rubber or synthetic rubber material to create upper and lower rubber or plastic coatings 200. Preferred sealing materials have a high elongation before breakage and high tear strength. Suitable materials may include many silicone rubbers, urethane and polyurethane rubbers, EPDM rubber (ethylene-propylene-diene monomer rubber), plastics, and the like. Shore hardness on drying may range dramatically according to the characteristics sought. The coating is applied at both the open upper and lower ends of the cylinder to render the hollow cylinder a sealed, hollow buoyant member.

Accordingly, when assembled, the upper end of the cylinder is sealed and the upper end of the line is disposed through the seal without compromising the water tightness of the upper end of the cylinder. Likewise, the coating over the weight and lower end of the cylinder creates a watertight seal connecting the weight to the cylinder.

Prior to use on a fishing line, an angler will select and purchase (or optionally assemble) the inventive apparatus with the right balance of buoyancy and weight to ensure sufficient mass for casting and for sinking the bait/lure and hook, for placement of the line, and for sufficient buoyancy to float the assembly at an optimum depth in the waters in which it will be used. Ideally, an angler would include a variety or assortment of the inventive apparatus in his fishing tackle, and these would comprise assemblies having different cylinder widths and lengths, different sinker weights, different colors (for lure compatibility), different flexibility characteristics (to better mimic native bait fish movement characteristics) and the like. In short, the apparatus is intended to complement and enhance tackle effectiveness, and thus to take angling yet another step forward in becoming a finely tuned science so that the art and beauty of fishing are better enjoyed.

The assembly is flexible and provides break-away capability, if needed.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A buoyancy compensating fishing weight apparatus, comprising:
a hollow cylinder having a sealed upper end and an open lower end;
a weight disposed on said lower end of said hollow cylinder;
a watertight seal affixing said weight to said lower end of said hollow cylinder; and
a line disposed through said seal in said upper end of said hollow cylinder.

2. The fishing weight apparatus of claim 1, wherein said hollow cylinder is at least slightly elongate, waterproof, buoyant, deformable and flexible.

3. The fishing weight apparatus of claim 2, wherein said hollow cylinder is fabricated from rubber.

4. The fishing weight apparatus of claim 1, wherein said hollow cylinder is fabricated from a closed cell foam.

5. The fishing weight apparatus of claim 1, wherein said watertight seal is made from a material selected from the group consisting of silicone rubber, urethane rubber, polyurethane rubbers, EPDM rubber, plastics, and any combination thereof.

6. A buoyancy compensating fishing weight, comprising:
a buoyant element;
a weight element;
a line element fixedly disposed through each of said buoyant element and said weight element; and
connection means for snap-on connection of said line element to a fishing line.

7. The apparatus of claim 6, wherein said buoyant element is a flexible cylinder having an upper end and a lower end.

8. The apparatus of claim 7, wherein said weight element is affixed with a watertight seal to said lower end of said flexible cylinder.

9. The apparatus of claim 8, wherein said connection means is a swivel.

10. The apparatus of claim 8, wherein said connection means is an eyelet.

11. The apparatus of claim 8, wherein said watertight seal is formed from a coating of cured deformable material selected from the group consisting of liquid silicone rubber, liquid urethane rubber, liquid polyurethane rubber, plastics and a combination thereof.
